(19) United States
(12) Patent Application Publication
(10) Pub. No.: US 2015/0339633 A1
(43) Pub. Date: Nov. 26, 2015

(54) SYSTEM AND METHOD FOR ORGANIZING AND FACILITATING MEAL-BASED MEETINGS

(71) Applicant: Mark H. Conner, Bellingham, WA (US)

(72) Inventor: Mark H. Conner, Bellingham, WA (US)

(21) Appl. No.: 14/722,092

(22) Filed: May 26, 2015

Related U.S. Application Data
(60) Provisional application No. 62/002,765, filed on May 23, 2014.

(51) Int. Cl. G06Q 10/10

(52) U.S. Cl. CPC G06Q 10/1095

(57) ABSTRACT

Systems, methods, and computer program products for providing and administering business-related meal meetings are provided, while also providing a seamless marketing tool for restaurants.

### PRIORITY

This application claims priority to and the benefit of U.S. Provisional Patent Application No. 62/002,765, filed May 23, 2014, which is fully incorporated herein by reference.

### TECHNICAL FIELD

The present invention relates generally to systems, methods, and computer programs for providing meal organization and arrangement solutions, especially for business meetings.

### BACKGROUND OF THE INVENTION

Conventional methods and services for organizing business-related breakfast, lunch and/or dinner meetings is decidedly inefficient, time consuming and costly. The process of selecting restaurants that meet budget requirements, sending invites, formulating a response by the attendees, following up with attendees, and administering or collating the orders, is disjointed and prone to error. Moreover, the current methods do not provide optimal advertising for the restaurant, and can create a sense of dissatisfaction with both the restaurants and the attendees.

Accordingly, there exists a need for new and improved meal organization methods and services for business meetings, to greatly increase efficiency, ease-of-use and overall seamless administration.

### SUMMARY OF THE INVENTION

Particular embodiments of the present invention are directed to a meal organization service including a web-site or application based system adapted to allow business to easily organize and administer meals for business meetings. The system allows the administrators or organizers to identify attendees by email address, date, time, etc., and budget the meeting and meals accordingly. The system can then provide a list of restaurants that meet certain attendee's criteria, including preferred cuisines and dietary restrictions. The system then emails service invitations for all of the attendees to join the website or app ordering service. From there, the attendees can place their detailed order, with the service then delivering the order to the restaurant for delivery or pickup. The service can further collect payments from the host or the multiple attendees and disburse payment to the subject restaurant.

In addition to providing increased efficiency and use for businesses and the meeting attendees, restaurants benefit from the service by receiving desirable exposure and often lasting business relationships.

The above and other aspects and embodiments are described below with reference to the accompanying drawings.

### BRIEF DESCRIPTION OF THE DRAWINGS

The accompanying drawings, which are incorporated herein and form part of the specification, illustrate various embodiments of the present disclosure and, together with the description, further explain the principles of the disclosure and to enable a person skilled in the pertinent art to make and use the embodiments disclosed herein. In the drawings, like reference numbers indicate identical or functionally similar elements.

FIG. 1 shows a system architecture diagram in accordance with exemplary embodiments of the present invention.

FIG. 2 shows a flow diagram of a home page process in accordance with exemplary embodiments of the present invention.

FIG. 3 shows a flow diagram of a member login process in accordance with exemplary embodiments of the present invention.

FIG. 4 shows a flow diagram of a member sign up process in accordance with exemplary embodiments of the present invention.

FIG. 5 shows a member dashboard screenshot in accordance with exemplary embodiments of the present invention.

FIG. 6 shows a flow diagram for a “book meeting” process in accordance with exemplary embodiments of the present invention.

FIG. 7 shows an annotated “book who” screenshot in accordance with exemplary embodiments of the present invention.

FIG. 8 shows a flow diagram for a “book who” process in accordance with exemplary embodiments of the present invention.

FIG. 9 shows a “book when” screenshot in accordance with exemplary embodiments of the present invention.

FIG. 10 shows a flow diagram of a “book when” process in accordance with exemplary embodiments of the present invention.

FIG. 11 shows a “book where” screenshot in accordance with exemplary embodiments of the present invention.

FIG. 12 shows a flow diagram for a “book where” process in accordance with exemplary embodiments of the present invention.

FIGS. 13-14 show “book what” and corresponding screenshots in accordance with exemplary embodiments of the present invention.

FIG. 15 shows a flow diagram for a “book what” process in accordance with exemplary embodiments of the present invention.

FIG. 16 shows a flow diagram for a “book select” process in accordance with exemplary embodiments of the present invention.

FIG. 17 shows a flow diagram for a “book choose” process in accordance with exemplary embodiments of the present invention.

FIG. 18 shows a flow diagram for a “book notice” process in accordance with exemplary embodiments of the present invention.

FIG. 19 shows an attendee email notification in accordance with exemplary embodiments of the present invention.

FIG. 20 shows a flow diagram for a meal order process in accordance with exemplary embodiments of the present invention.

FIG. 21 shows a web ordering screenshot in accordance with exemplary embodiments of the present invention.

FIGS. 22a-22b show mobile or tablet app ordering screenshots in accordance with embodiments of the present invention.

### DETAILED DESCRIPTION OF PREFERRED EMBODIMENTS

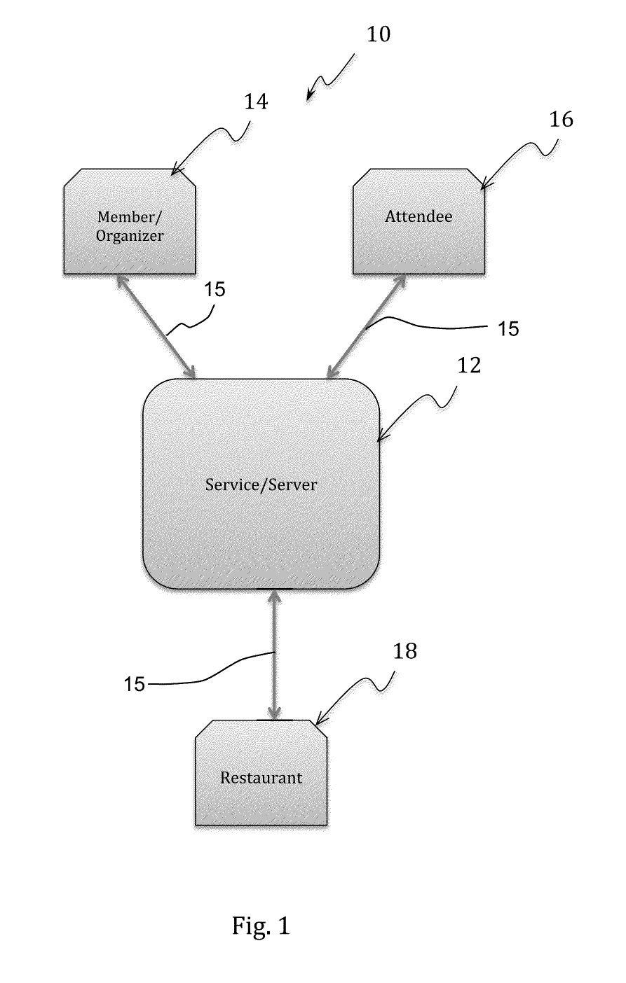

Referring generally to FIGS. 1-22b, exemplary systems, methods, and computer program products or processes for providing and administering business-related meal meetings are provided, while providing a seamless marketing tool for restaurants. Businesses need to arrange meals for meetings and other events, and restaurants strive to expand sales. Both the businesses arranging, and the restaurants providing, the meals are able to provide a highly configurable and customizable experience for the meeting attendees.

Various terminology is provided throughout the disclosure and can include, but is not limited to, the following. Member: a company, government agency or any other organization that uses the meal services or computer products to arrange meals for a fee. Restaurant: a restaurant that receives orders from the meal services or computer products for a fee. Attendee: an individual that is participating in a meeting and ordering food. Host: the individual hosting the meeting. He/she can also be a meeting attendee, but their preferences are used in the restaurant Selector. Meeting: an event hosted by the host, organized by the organizer, attended by the attendees, catered by the restaurant, and paid for by the member or attendees. Location: a specific location where the meal will be delivered and the meeting held. A location can be a separate facility or a separate conference room within the same facility. It is also useful when a third party (e.g., drug rep, sales personnel, etc.) is hosting the meeting—the member can be the sales rep's company but the location can be the business that he/she is hosting. Organizer: the individual that will use the meal services or computer products to schedule the meeting. This person may or may not be an attendee, or could also be the host. The organizer is associated with a member. User: a user of the meal services portal for restaurants; can be organizer or other user of the service. Other related terminology is also available and may be used throughout the disclosure to describe the various participants in and the functions and events of the system.

In general, the system 10 provides a website, app, or the like, that allows one or more admins to identify attendees by email address, date, time of meeting, budget, etc. The service then performs processing and provides or outputs a list of restaurants that meet predefined criteria for the admin organizer to select from. Next, email or other electronic transmittal invites are sent to all attendees with a link (via HTML link, linked tab, etc.) to the service where they can order off of the restaurant's menu (based on the predefined criteria). The food order is sent by the system (e.g., email, fax, or interface to POS system) or otherwise delivered to the restaurant, and the restaurant delivers the food. The service can electronically collect payment from either the member or attendees, and disburses or electronically sends the payment to the restaurant. As a result, restaurants are matched and gain exposure with customers that are a good fit based on budget, location, hours of operation, cuisine type, dietary requirements, and various other criteria.

Referring now to FIG. 1, exemplary architecture of a meal organization system 10 in accordance with embodiments of the present invention is illustrated. The system 10 includes at least one meal ordering web server or service 12, at least one organizer device 14, at least one user device 16, and at least one restaurant device 18, wherein each of the devices 14, 16, 18 are configured to directly or indirectly communicate with the service 10 over communication or network channels 15 (e.g., the internet). Examples of various devices can include a computer (e.g., laptop or desktop), a tablet (e.g., an iPad), and a mobile device (e.g., a smartphone). The user interaction and systems, methods, and computer programs of the present invention can, for example, be deployed as a client-server implementation, as an ASP model, or as a standalone application running on a device. In certain embodiments the program or software is a “web app,” such as an HTML5 app, or a software/smartphone/mobile app.

The exemplary servers of the present invention are configured to generate, maintain, and host the computer program product in various embodiments. The servers generate, maintain and host web pages (e.g., HTML documents) that embody the present invention. The servers can include services associated with rendering dynamic web pages, such as data storage services, security services, etc. Accordingly, the servers can include a hardware arrangement and can be outfitted with software and/or firmware for performing web server functions for performing aspects of the present invention, such as, for example, javascript/jquery, HTML5, CSS2/3, SSL, and facilities for Kendo UI, JSON web services, node.js, MySQL, MongoDB, PHP, SOAP, Caché, etc.

The servers may be coupled with a data storage facility, which may include one or more local or remote memory systems or units, and can include one or more databases and/or file systems for storing data, media, graphics, HTML documents, XML documents, etc.

The at least one server 12 can be configured to include admin functionality, which enables an administrator to perform system-related functions. The system-related functions can include maintaining user records, interacting with third party services and servers, performing upgrades on the software, and facilitating the exemplary certification or verification services disclosed herein.

The devices 14, 16, 18 may include a processor, which may include one or more microprocessors and/or one or more circuits, such as an application specific integrated circuit (ASIC), field-programmable gate arrays (FPGAs), etc. Further, the devices can include a network interface. The network interface is configured to enable communication with a communication network and servers, e.g., using a wired and/or wireless connection.

The devices may include memory, such as non-transitive memory, which may include one or more non-volatile storage devices and/or one or more volatile storage devices (e.g., random access memory (RAM)). In instances where the devices include a microprocessor, computer readable program code may be stored in a computer readable medium or memory, such as, but not limited to magnetic media (e.g., a hard disk), optical media (e.g., a OVO), memory devices (e.g., random access memory, flash memory), etc. The computer program or software code can be stored on a tangible, or non-transitive, machine-readable medium or memory. In some embodiments, computer readable program code is configured such that when executed by a processor, the code causes the device to perform the steps described herein. In other embodiments, the devices are configured to perform steps described herein without the need for code.

It will be recognized by one skilled in the art that these operations, algorithms, processes, logic, method steps, routines, sub-routines, and modules may be implemented in software, in firmware, in special purpose digital logic, and any combination thereof without deviating from the spirit and scope of the present invention as recited within the claims attached hereto.

The devices may include an input device. The input device is configured to receive an input from either a user (e.g., admin, user, or restaurant) or a hardware or software component. Examples of an input device include a keyboard, mouse, microphone, touch screen and software enabling interaction with a touch screen, digitizer or electronic stylus input, etc. The devices can also include an output device. Examples of output devices include monitors, televisions, mobile device screens, tablet screens, speakers, remote screens, electronic communications, etc. The output device can be configured to display images, output data or instructions, media files, text, or video, or play audio to a user through speaker output.

Server processing systems may include one or more microprocessors, and/or one or more circuits, such as an application specific integrated circuit (ASIC), field-programmable gate arrays (FPGAs), etc. The network interface can be configured to enable communication with a communication network, using a wired and/or wireless connection. Memory can include one or more non-volatile storage devices and/or one or more volatile storage devices (e.g., random access memory (RAM)). In instances where the server system includes a microprocessor, computer readable program code may be stored in a computer readable medium, such as, but not limited to magnetic media (e.g., a hard disk), optical media (e.g., a DVD), memory devices, etc.

Various steps and methods of a meal organization and facilitation system 10 in accordance with embodiments of the present invention are provided. The system 10 or software product can include a home or dashboard component/method, a membership component/method, a meeting component/method, a restaurant component/method, and an ordering component/method. Each of the components or methods can be configured to display on and receive input at the user devices. Further, data processing can take place at the devices 14, 16, 18 and/or at the at least one server 12.

### Home Intro Component

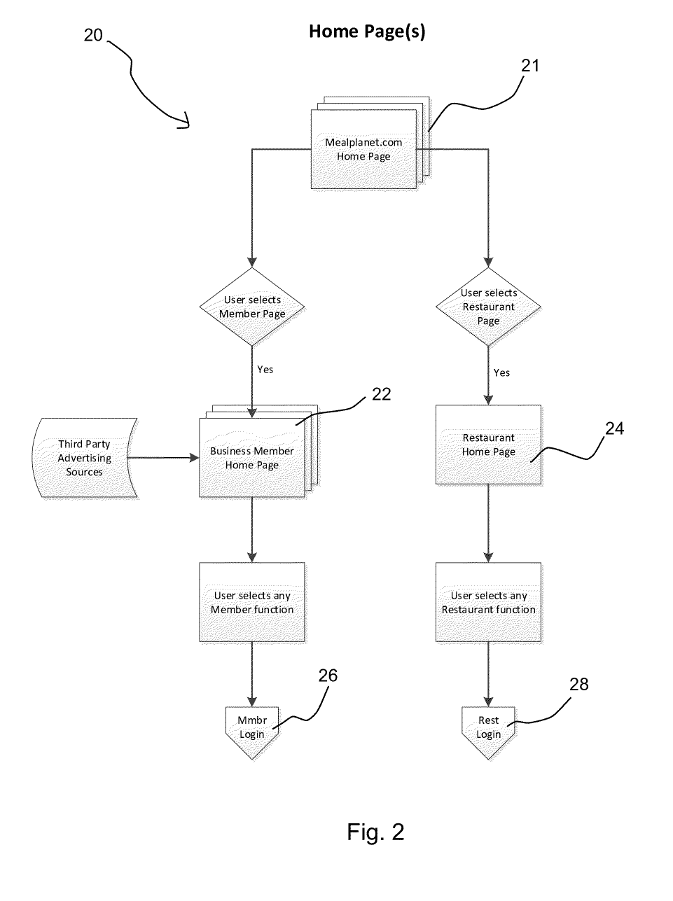

The home component or method 20 can include an initial start or dashboard display portion 21, as detailed in the diagram of FIG. 2. One or more base home page screens can be displayed, or selectively provided for user input. In particular, links, pages, or other indicia can be presented for input selection, which will direct the user to member page 22 or restaurant page 24. These pages can include member registration or login options 26, and restaurant user registration or login options 28. Both the member and restaurant users can select various service functions and proceed to the login options 26, 28. At any point during the home page screen display and input display options, third party and restaurant advertisements can be processed and displayed on device screens.

### Membership Component

A member signup or configuration output can be displayed to new members (e.g., organizers) on any of the user devices. Various testimonial videos, restaurant lists, FAQs, etc. can be displayed for the organizer. The sign-on dialogue windows or input regions can enable the members to input username, password, and other relevant contact information. From there, a member can easily begin the process for booking a particular meeting.

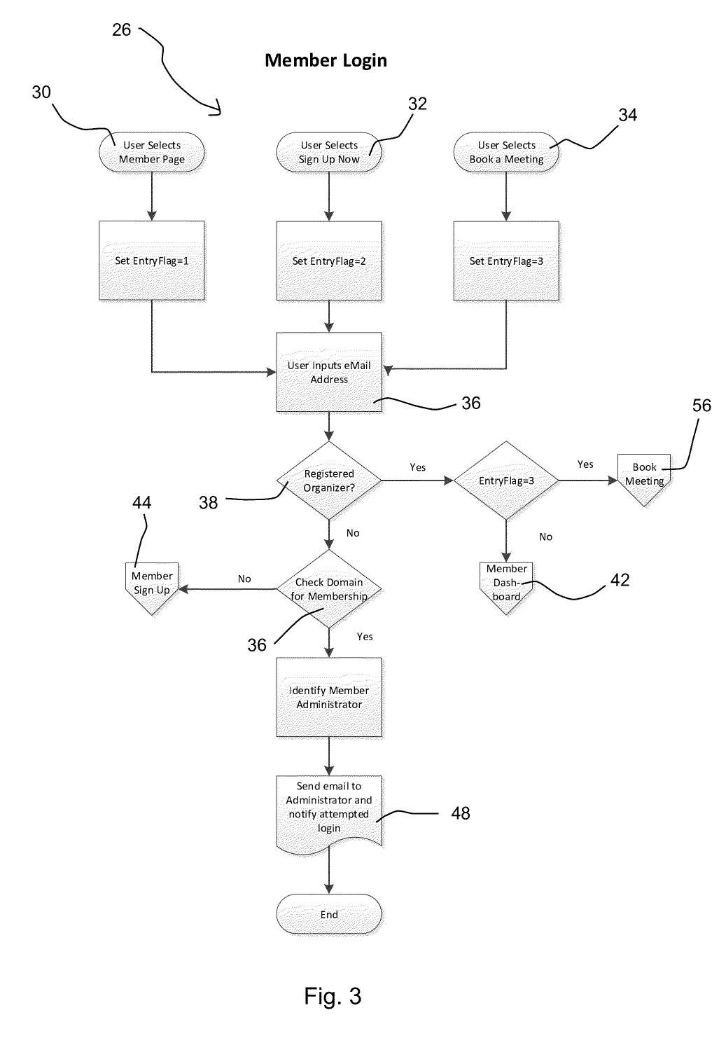

FIG. 3 shows certain method steps for members to log in to the system 10 via method 26. The member organizer device can receive a series of login inputs or screen displays, adapted to provide unique access to various options. For example, the members can select from member page select 30, sign up select 32, or “book a meeting” select 34 options.

Upon selecting one of the referenced select options, members can input their email addresses, password, or other identifying information at step 36 and the service will determine, based upon processing of the subject input, whether the organizer is already registered within the system at step 38 (e.g., database processing and verification). If the member is registered, the service redirects the user to their respective member page and can thereby schedule a meeting at process 56. If the member is not registered, the member can be directed to a sign-up option for the service at member dashboard 42.

If the member organizer is not a registered user, the system 10 can perform a membership check at step 46 to identify whether a member administrator exists—e.g., read the domain portion of the inputted email address and compare it to a domain table to identify and obtain the administrator information. If the membership is not confirmed then the user can be directed to the member sign up option 44. If so, the system can send an email or other communication to the identified administrator to provide notice of the attempted login at step 48.

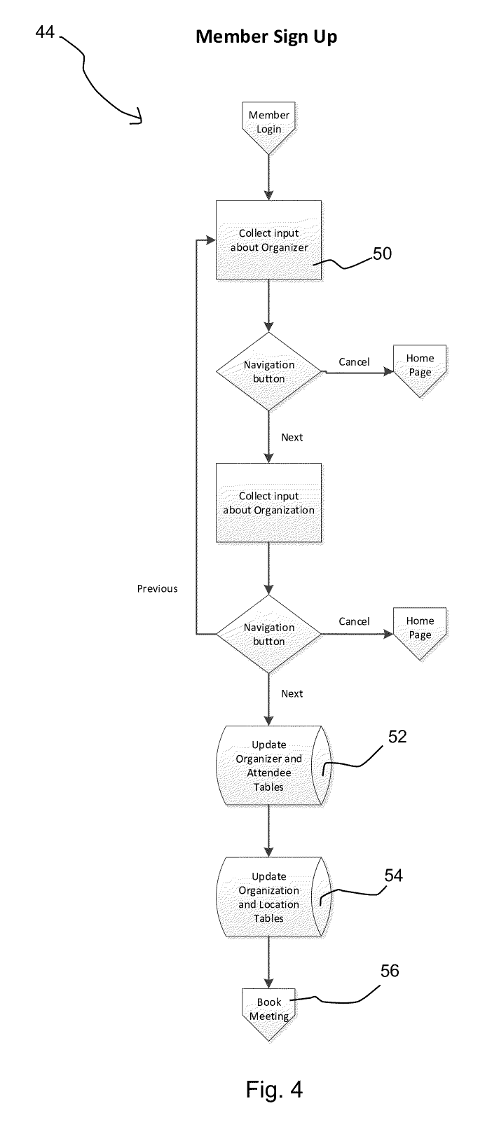

FIG. 4 depicts a member sign-up process 44 in accordance with embodiments of the present invention. This process can display a plurality of data fields for the organizer to input identifying information 50, such as name, email address, physical address, attendee information, phone number, delivery instructions, other instructions, and the like. The inputted organizer, attendee, organization and like data is then stored in a table or database of the server at steps 52, 54, and the organizer is directed to the meeting/booking setup option 56.

### Meeting Component

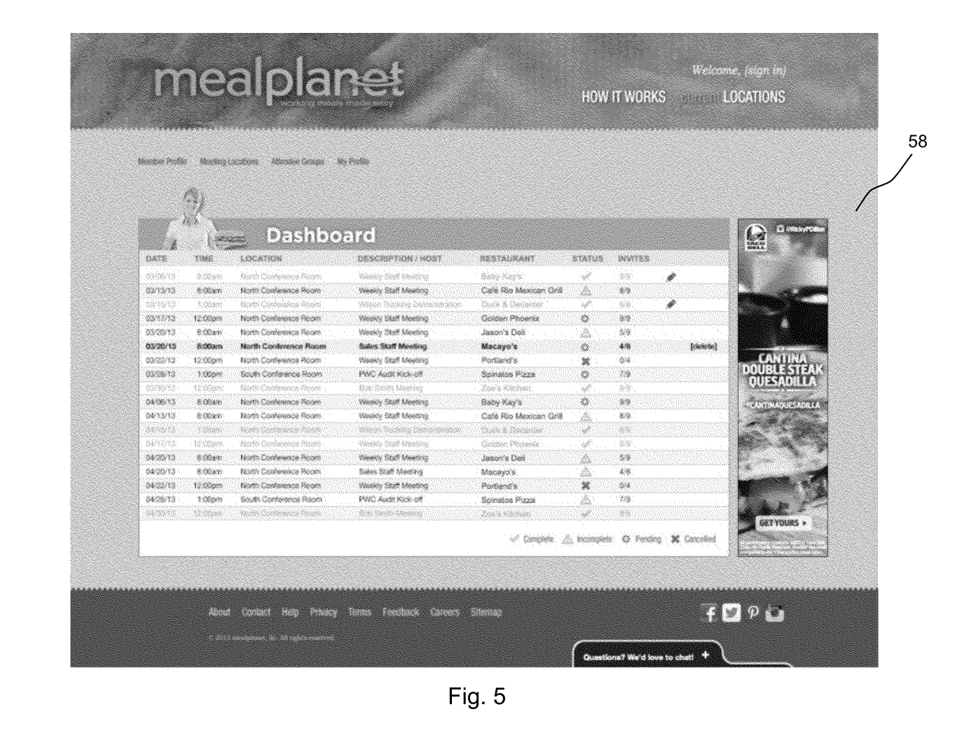

FIG. 5 shows an exemplary embodiment of a meeting dashboard 58, which can be displayed to allow members to view, organize, edit, complete, and cancel meetings. This can provide a quick way to view meetings and perform various editing functions. Further, the dashboard can provide a displayable area for banner advertising and navigation options. For particular meetings, the dashboard 58 can display the date, time, location, description, restaurant, status (e.g., incomplete, pending, order sent, delivered, complete, cancelled, etc.) for recent and upcoming meetings. Member profile details and editing options can also be made available at the dashboard portion of the service. For instance, user selection of input options/tabs permits modification of the member table (edit fields, save, cancel, etc.), the location table, the attendee table, the organizer table, etc. In addition, the member organizer can select a survey or like input option to rate various stored restaurants.

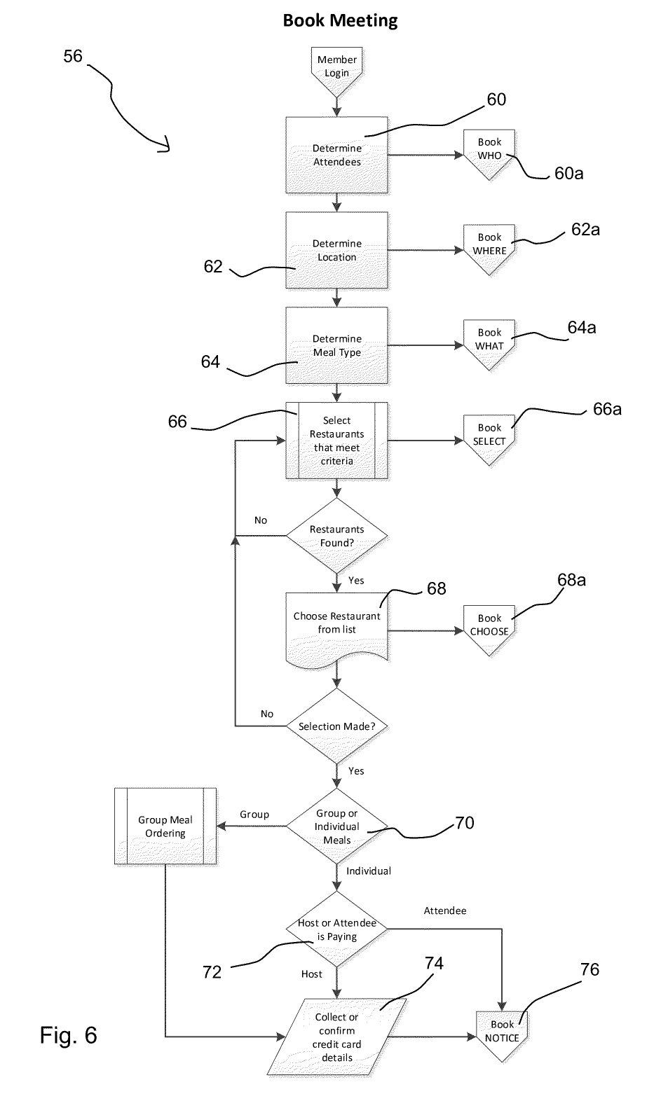

As shown in FIG. 6, there are various options available for a member to book or schedule a meeting at booking process 56. The booking process can obtain information inputs from the members to establish essential details of the meeting in accordance with the following steps: who will attend the meeting 60, the location and time of the meeting 62, the meal type 64, and restaurant selection 66. As such, each of these steps (60-66) corresponds to separate processes for booking the meeting: “book who” process 60a, “book where” process 62a, “book what” process 64a, and “book select” process 66a, which are detailed further herein.

Upon completion of the above-referenced processing, a restaurant for the meeting is finally selected at step 68 with a corresponding “book choose” process 68a initiated to display options and permit user selection of the preferred meal catering provider. Then, the organizer can select whether a meeting will include individual or group meal options at step 70, and whether the host or the attendees will be paying for meals at step 72. From there, payment details (credit card, Pay Pal, etc.) are inputted by the organizer for payment of the meeting at step 74. Upon completion, a notification of the set meeting and the subject details associated with the meeting are send out at “book notice” step 76.

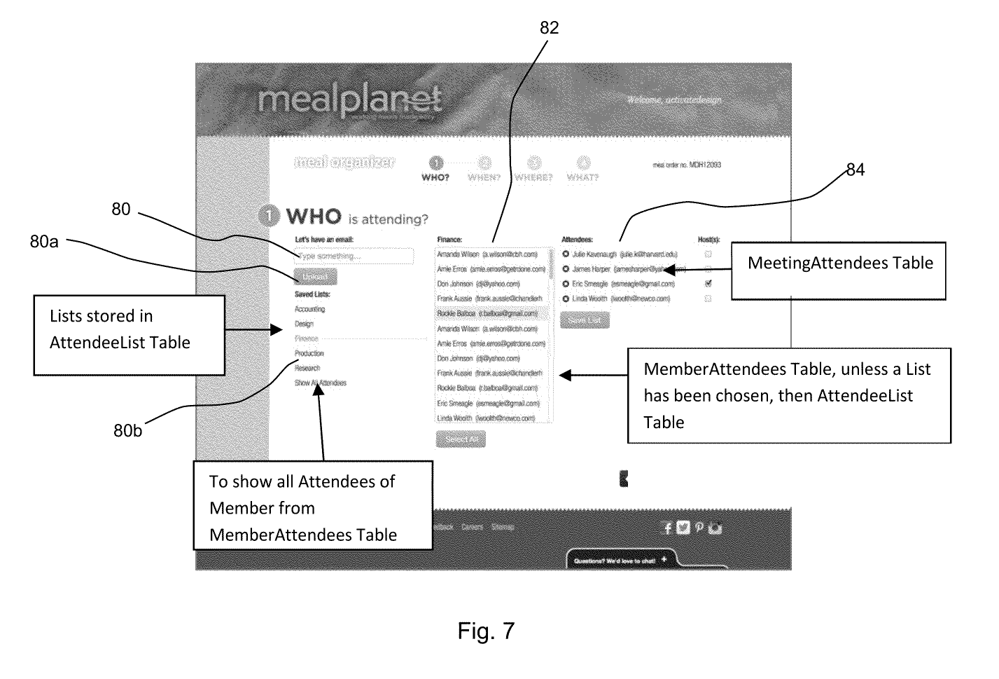

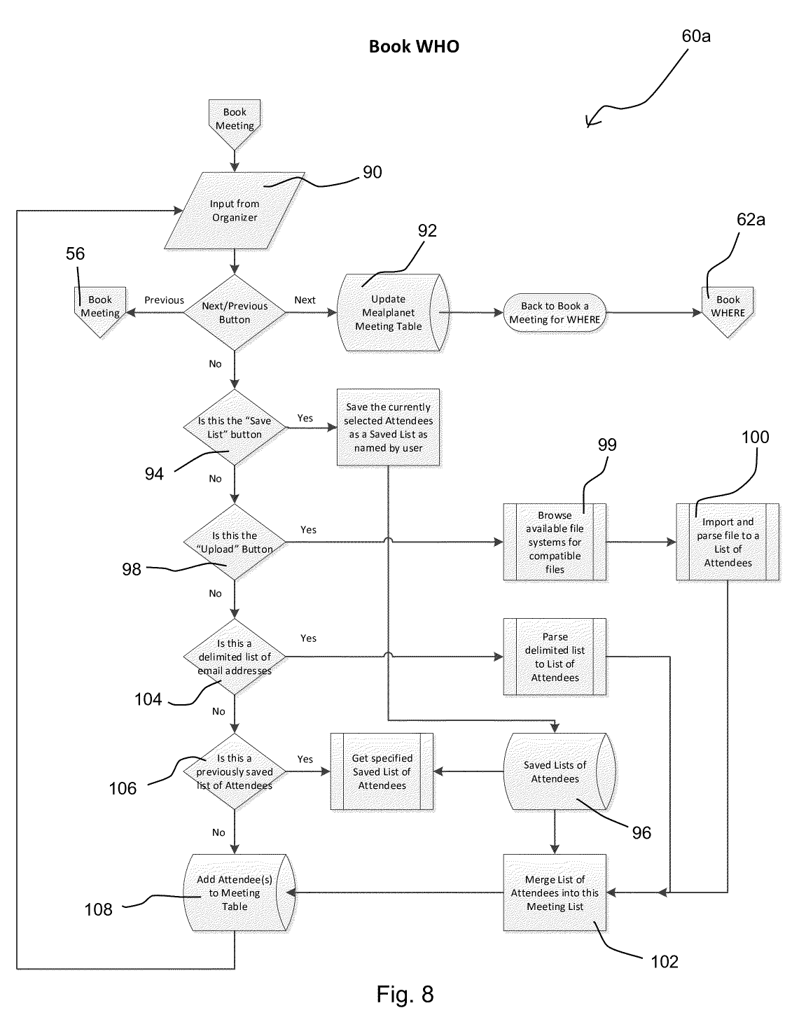

As shown in FIGS. 7-8, the “book who” process 60a is detailed in accordance with embodiments of the present invention. FIG. 7 is an exemplary display screenshot of the process, providing input options for the meeting at region 80, attendee category display and selection at region 82, and attendee display and selection at region 84. An attendee identifier upload option 80a is provided, as well as a saved list category option 80b (e.g., accounting, finance, engineering, legal, and a myriad of other business categories). Selection of an “all attendees” option can also be displayed at 80b.

Referring to the process diagram of FIG. 8, the organizer can input an attendee identifier at step 90—e.g., the email address of the attendee. From there, the organizer can select to proceed to the “book where” process 62a, or proceed with further data inputs. If the next step is selected, the inputted attendee identifier is stored in a meeting database or table at 92 and the organizer is directed to the “book where” process. However, the organizer can further proceed with process 60a. For instance, at step 94, the organizer can select to save an attendee list based on the one or more attendees entered. Attendee lists are processed and stored at a table or database 96 on the server.

Further, the attendee details can be uploaded to the server and the “book who” process at step 98. Namely, the organizer can select the upload input option 80a and proceed with selecting (e.g., file or application browsing) a compatible file type on a user device (e.g., .txt, .csv, Excel, Word, etc.) at step 99. The service will read, process, and parse an invite notification or individual contact data automatically from the uploaded file and preload attendee information at step 100, and store the parsed information into the meeting list at step 102. Further, a delineated list of email addresses can be read, processed, and parsed out at step 104 to provide additional attendee data to the meeting list (e.g., 102).

In addition to uploading attendee information, a previously saved list of attendees is displayed at region 80b and can be selected by the organizer at step 106. The attendees of the selected attendee category can be displayed at region 82 (e.g., email, name, etc.). The organizer can select all of the saved list attendees for the meeting, and/or individually select attendees from the saved list. Again, the saved list of attendees can come from the information stored at data storage 96. All of the selected attendees for the meeting can be merged into a meeting list at 102 (e.g., parsed list of attendees from 100, saved list of attendees from 96, etc.). Additional inputting can take place at step 108, wherein the organizer can continue the input process at step 90. Auto-fill functionality for inputted data, such as email addresses and names, can be employed. Upon completion of selecting attendees, the current list of attendees can be saved to the attendee data table 96. A member attendee table can be provided to store all attendees that have been invited to meetings of members.

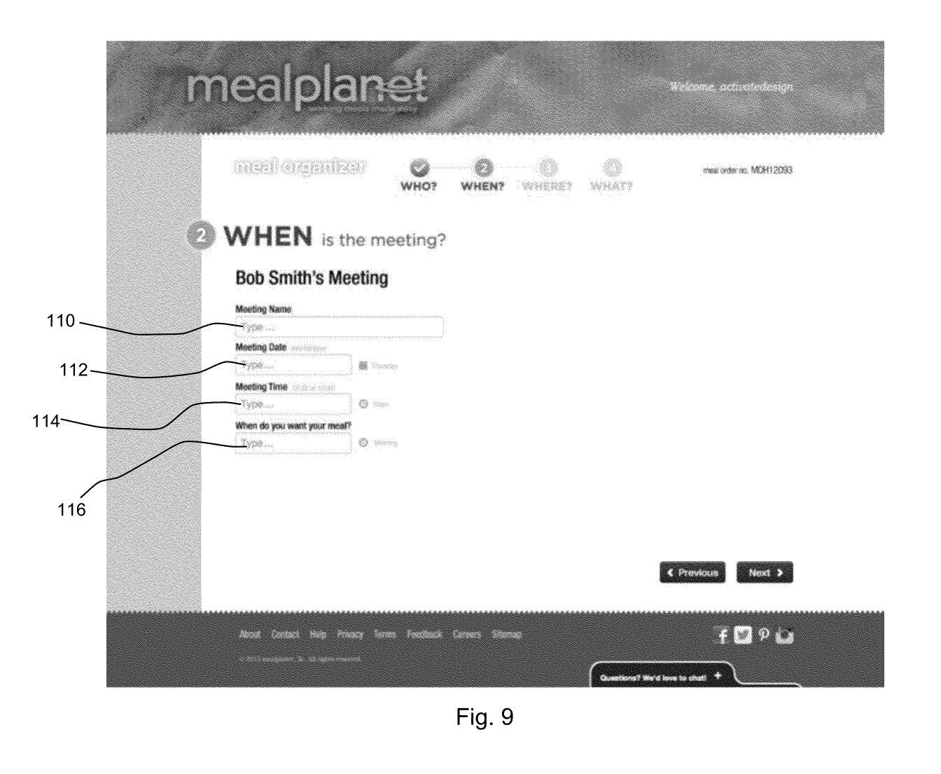

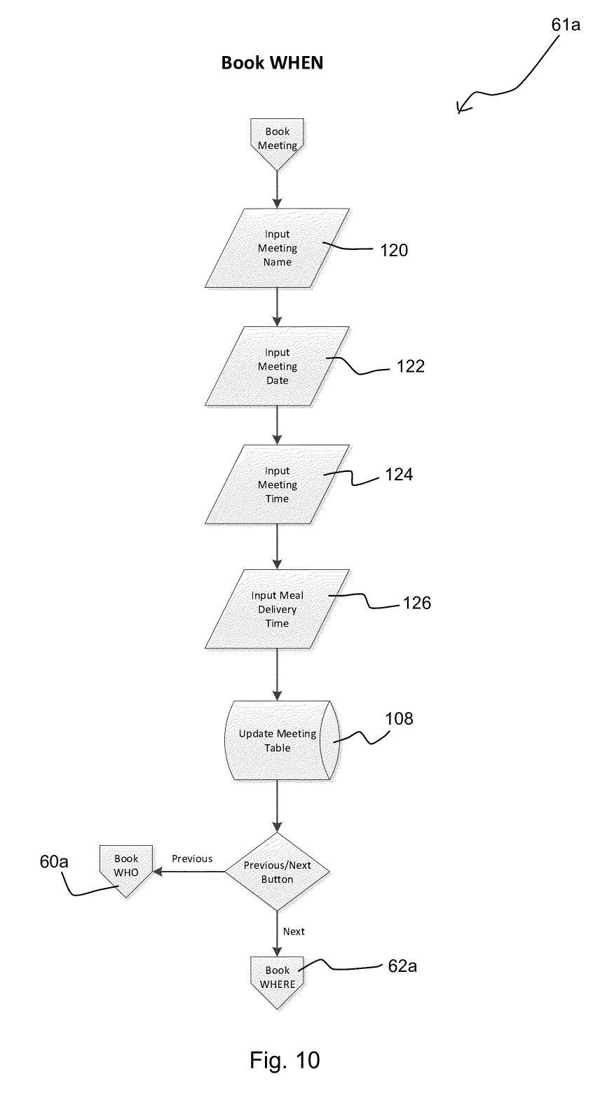

Referring to FIGS. 9-10, a “book when” process 61a can be initiated to process and store the timing information for a meeting. As shown in FIG. 9, various input fields and options can be displayed for the organizer, such as a meeting name region 110, a meeting date region 112, a meeting time region 114, and meal timing region 116—as associated with the process steps of FIG. 10. Correspondingly, the organizer inputs a meeting name at step 120, a meeting date at step 122, a meeting time at step 124, and a meal delivery time at step 126. The inputted data from the organizer is stored in or updated to the meeting table 108. The organizer can then proceed to the previous “book who” process 60a, or next to the “book where” process 62a.

When the organizer is creating the original electronic meeting invite outside of the service (e.g., in MS Outlook or other scheduling software), they can include a predefined service email address or identifier (e.g., meeting@mealplanet.com). If so, the system 10 will receive the invite, and based on the content of the invite will parse or extract out information such as the organizer, date, time, and all of the attendees invited. This will enable the system to pre-create, or at least partially pre-create, the meeting and pre-load the “who” and “when” data, thereby saving the organizer a great deal of time. In these situations, the organizer may only need to input the “where” and the “what” for the meeting. In certain embodiments, all of the meeting information, including the “where” and “what” could be detailed in the electronic invitation to complete the various meeting subject fields, tables, and database information for a particular meeting.

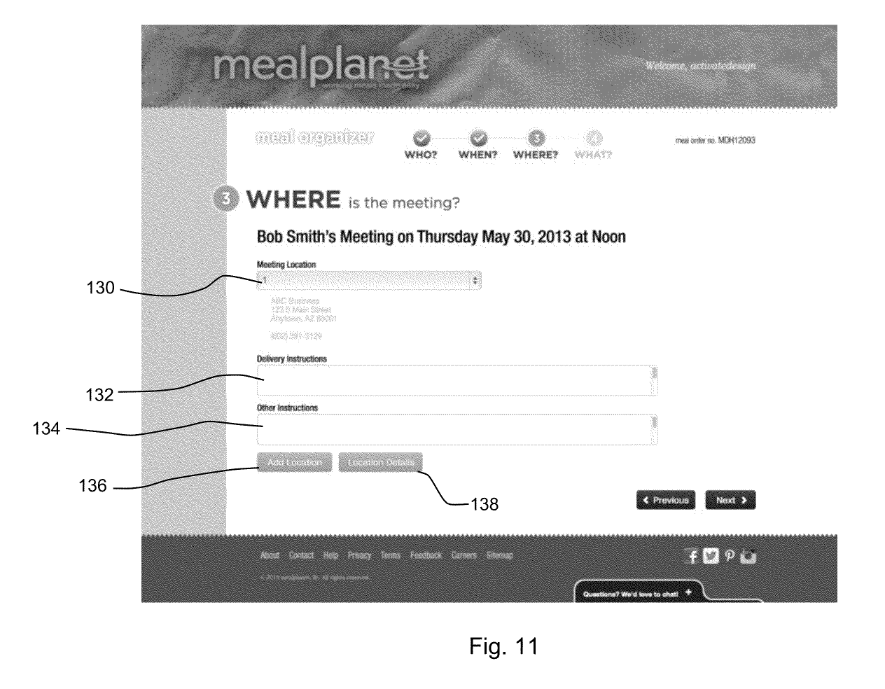

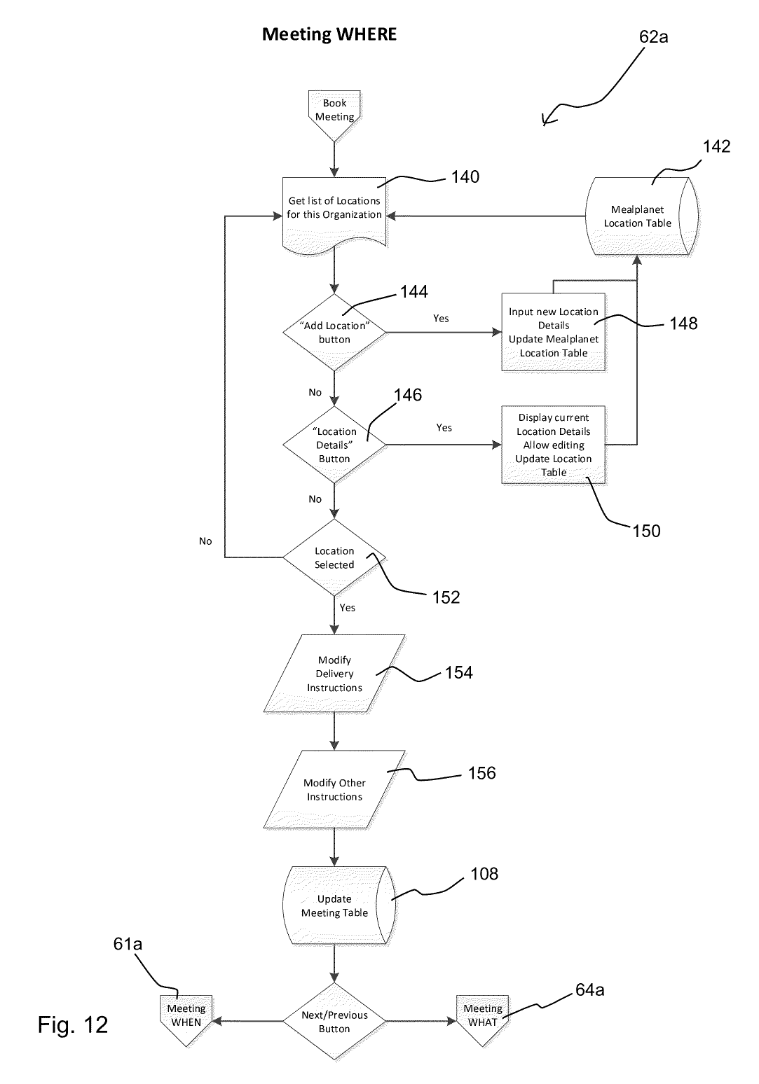

Referring to FIGS. 11-12, a “book where” process 62a can be initiated to process and store location information for a meeting. FIG. 11 depicts various input fields and options displayed for the organizer, such as meeting location 130, delivery instructions 132, other instructions 134, add location 136, and location details 138—as associated with the process steps of FIG. 12.

As shown in FIG. 12, the displayed list of meeting locations for the particular registered organization can be retrieved at step 140—e.g., from an existing location table or database 142 on the server. The organizer can elect to add a location at step 144, or add location details at step 146. New inputted locations from 144 can be processed and the location table 142 can be correspondingly updated at step 148. Similarly, location details can be inputted and/or edited from existing details, and then processed and used to update the location table 142 at step 150.

An organizer can select the desired location from the displayed options at step 152, and further input delivery or other various instructions 154, 156, such that the inputted data is thereby updated to the meeting table at 108. Input options are displayed to allow the organizer to return back to the “book when” process 61a, or next to the “book what” process 64a.

A member organizer can have many associated restaurant locations saved on the server. The location can be a separate physical location, multiple conference rooms in a facility, a rented room, etc. As the details of the location are inputted, the displayed details for the meeting, as shown in FIG. 11, are likewise expanded. Further, whether the organizer is entering or selecting a meeting location via a web browser or a mobile/tablet application, geo-location services can be incorporated with the system to identify or narrow the list of available locations for the organizer, such that those restaurant options within a pre-defined radius or distance are retrieved from the server, or a third-party geo-location service, and initially displayed to further facilitate location selection.

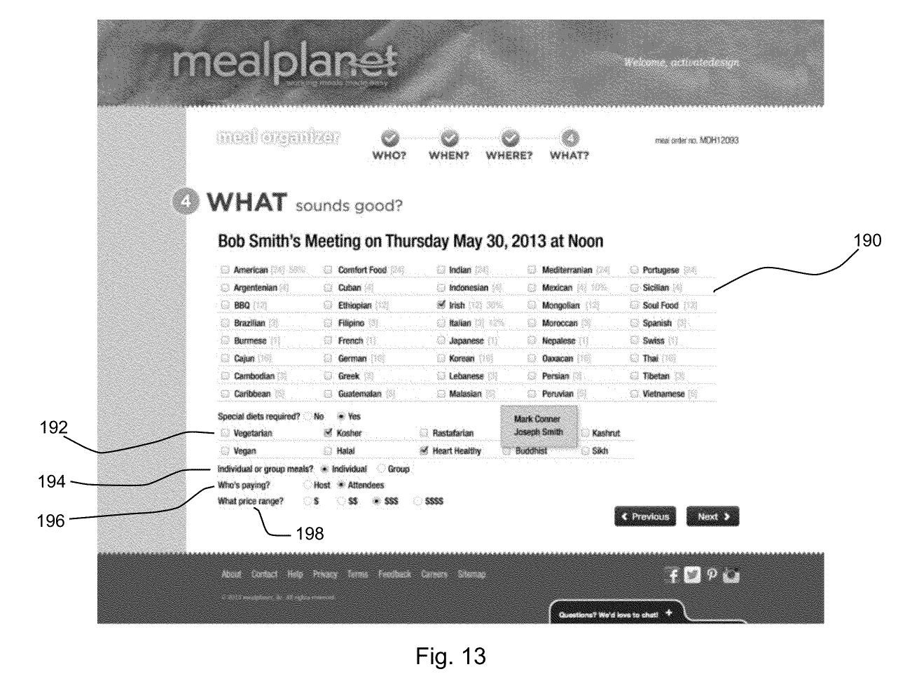

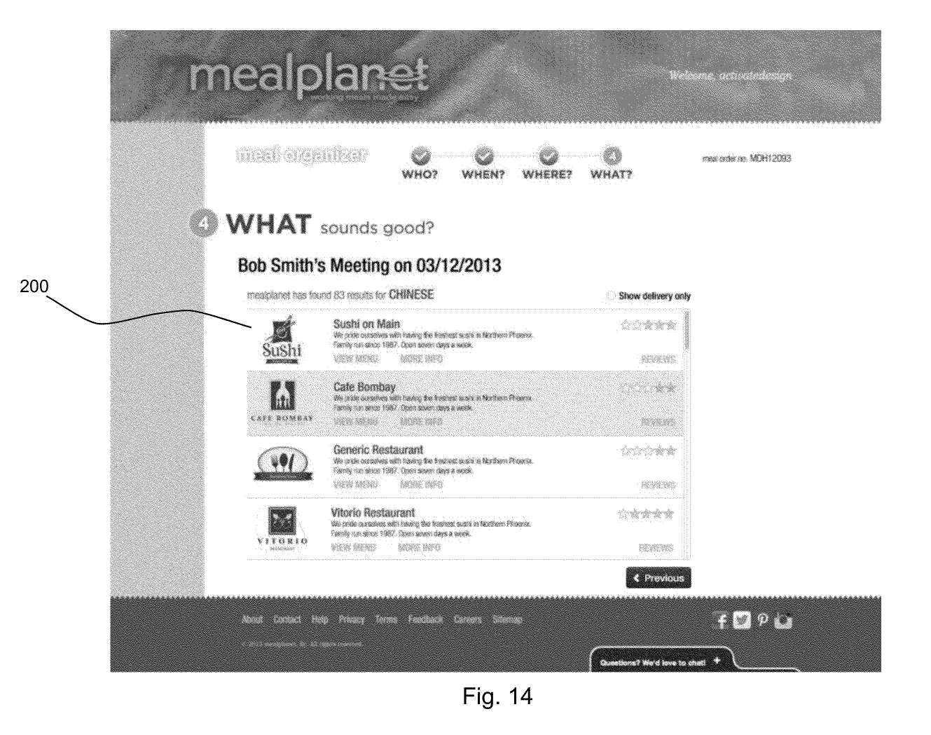

Referring to FIGS. 13-17, a “book what” process 64a, a “book select” process 66a, and a “book choose” process 68a are provided. The “book what” process 64a permits the organizer to view, select, and control the catering of the meeting by one or more specific restaurants. FIGS. 13-14 depict the restaurant selection criteria and details for the processes.

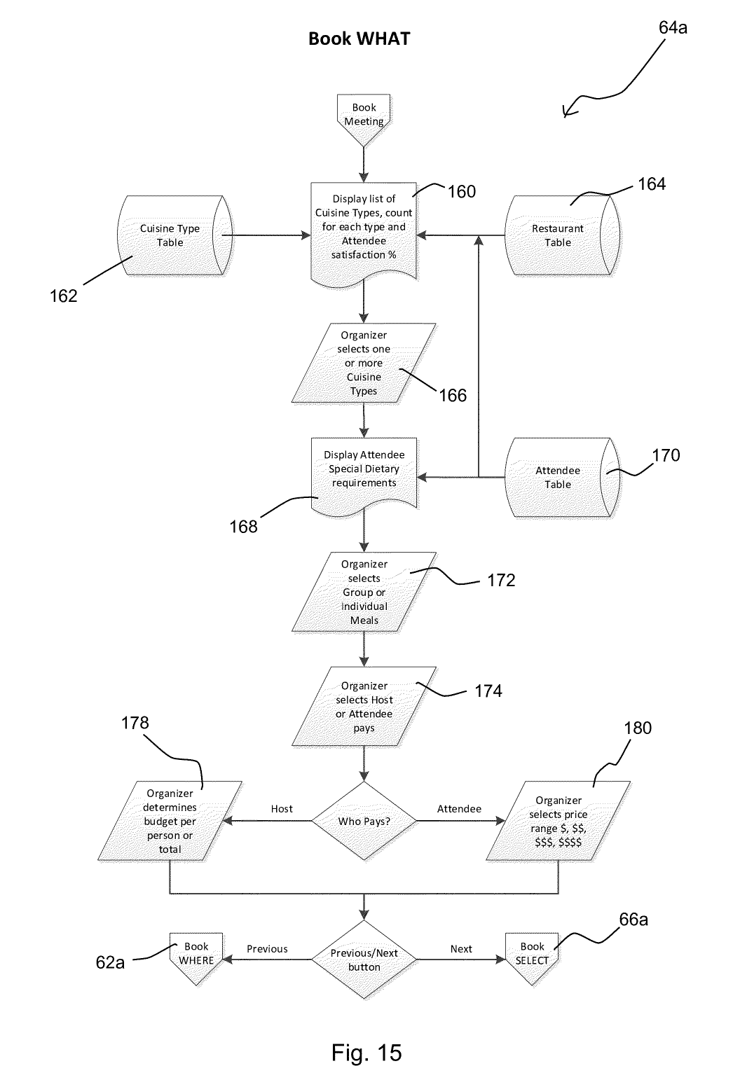

FIG. 13 shows the various input options displayed to the organizer user at a cuisine type region 190, a special diet region 192, individual/group meal region 194, and price range region 198. Again, these input regions correspond to the data for the processing steps of FIG. 15. FIG. 14 shows the final restaurant selection region 200 for the organizer. The region 200 can display a scrollable or other list format of the restaurants (e.g., by cuisine type) for the organizer to select for the meeting. The displayed details can include pictorial and/or text summaries of the restaurants, and can include reviews or other restaurant information.

The process 64a includes an initial display list 160 that receives data from the cuisine type table 162 and the restaurant table 164, providing a count for each cuisine type and attendee satisfaction percentage. The organizer selects one or more cuisine types (e.g., American, Chinese, Mexican, Italian, Irish, etc.) at step 166. Special dietary restriction options (e.g., Vegan, Heart Healthy, Kosher, gluten free, etc.) are displayed for organizer selection at step 168. The special dietary options can be received from the attendee table 170, which in turn can receive specific restaurant details from the restaurant table 164. The organizer can select whether the meals will be group or individual meals at step 172, and then selects whether the host or attendee will pay for the meal at step 174. If the host is designated to pay, the organizer can input the parameters of the budget for a single person at the meeting, or for the total meeting attendance, at step 178. If the attendee is selected to pay, the organizer can select the price range indicators (e.g., from low to high priced meals) at step 180. Upon completion of the payment selection options, the organizer can select to go back to the “book where” process 62, or to proceed to the next “book select” process 66a.

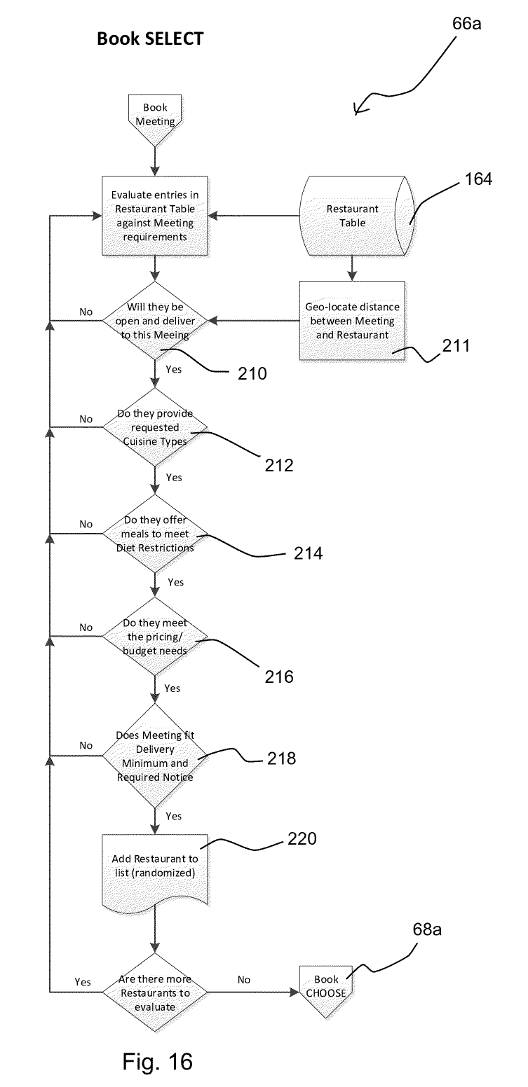

The “book select” process 66a of FIG. 16 begins with processing of the entries from the restaurant table to evaluate against the meeting requirements. Namely, in various embodiments, the server will process whether the restaurant will be open and available for delivery for the particular meeting time at step 210, whether the restaurant provides the requested cuisine types at step 212, whether the restaurant offers meals to meet the selected diet restrictions at step 214, whether the restaurant meets the selected pricing or budget needs at step 216, and whether the meeting matches with the delivery minimum (e.g., minimum dollar amount) and required notice (e.g., notice period prior to delivery) criteria for the restaurant at step 218. Upon completion of this evaluation, the restaurants that meet each of the criteria above are added to an acceptance list for the organizer at step 220. The list can be organized or sorted randomly, alphabetically, based on review status, etc. This process runs through each of the restaurants until there are no longer any restaurants to evaluate from the restaurant table. If all available restaurants have been evaluated, the “book choose” process 68a is initiated.

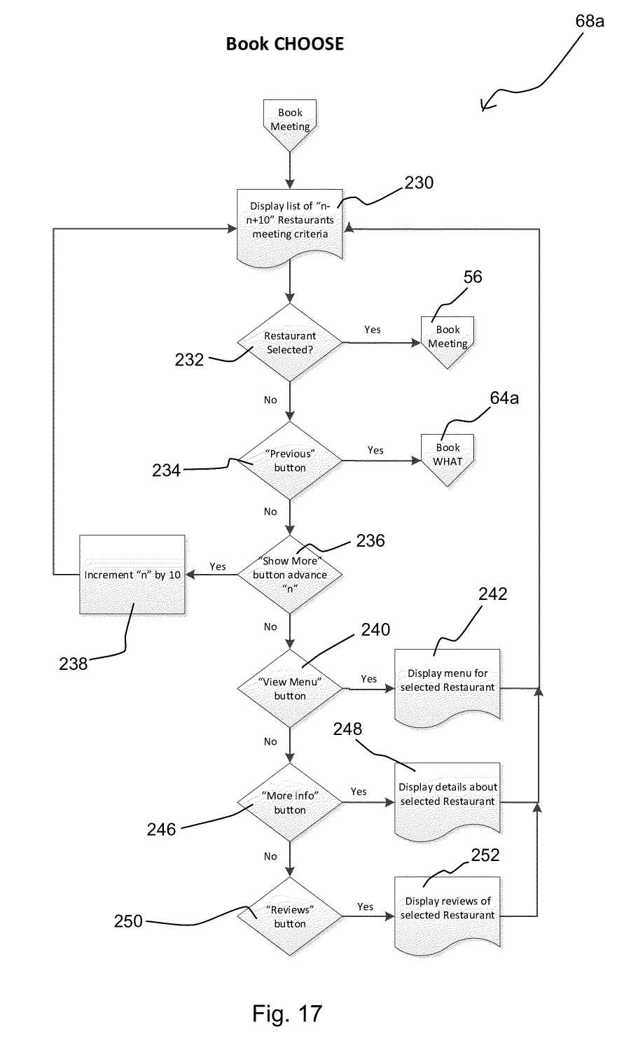

FIG. 17 depicts the “book choose” process 68a of the present invention, corresponding to the screenshot depiction of FIG. 14. The list of restaurants that meet the above-evaluated criteria are listed for the organizer at step 230. If a restaurant is selected at step 232, the organizer is directed to the “book meeting” process 56. Alternatively, the organizer can select a previous select option at step 234 and return back to the “book what” process 64a. A selection can also be made at step 236 to show more restaurants, wherein the restaurant list is again displayed at 230.

The organizer can select to view a selected restaurant's meal menu at step 240. If selected, the menu is displayed at step 242. Further, the organizer can select a “more info” or like options at step 246, thereby causing additional details to be displayed about the selected restaurant at step 248. The organizer can also select to view reviews for the restaurant at step 250, which will cause the stored or linked views to be displayed at step 252. Again, at any point during this process (e.g., viewing and interacting with the screen of FIG. 14), the organizer can use the displayed and collated information to click on or otherwise select the restaurant via step 232.

Once the various options have been displayed by the system 10 and inputted by the organizer, the order details (e.g., the “who,” “when,” “where,” and “what”) can be displayed to the organizer in a summary fashion—permitting the organizer to make a final confirmation selection of the meeting details.

Once the details have been inputted for the meeting, the service 10 can then, optionally based on the restaurant preferences, send notice to the restaurant to either accept or decline catering for the meeting, as detailed below. Further actions from the service 10 can include monitoring attendee responses, sending ordering reminders to the attendees, and sending the final order details to the restaurant (e.g., via email, fax, or interface with POS system).

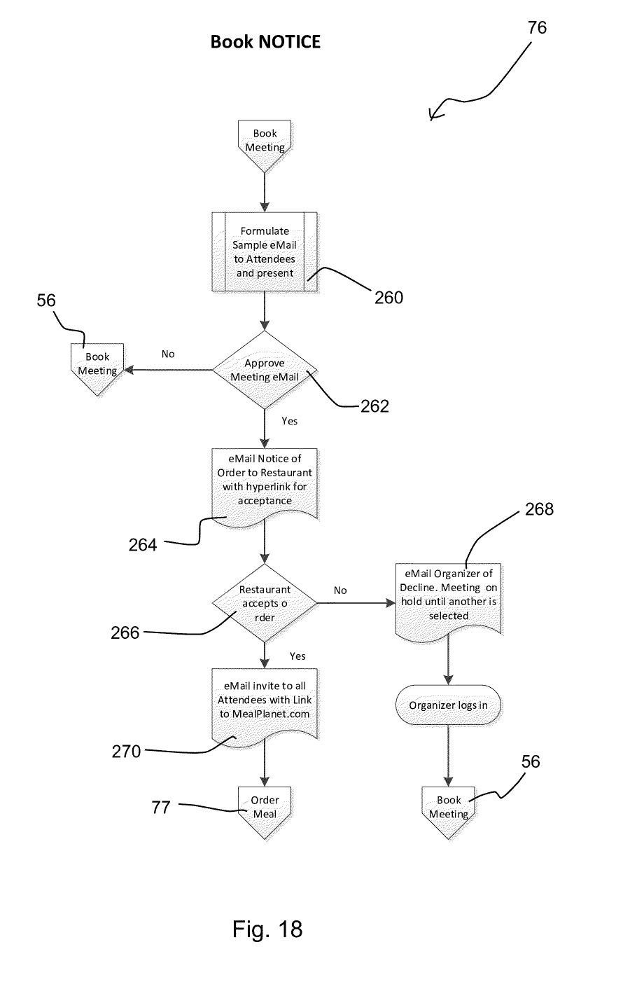

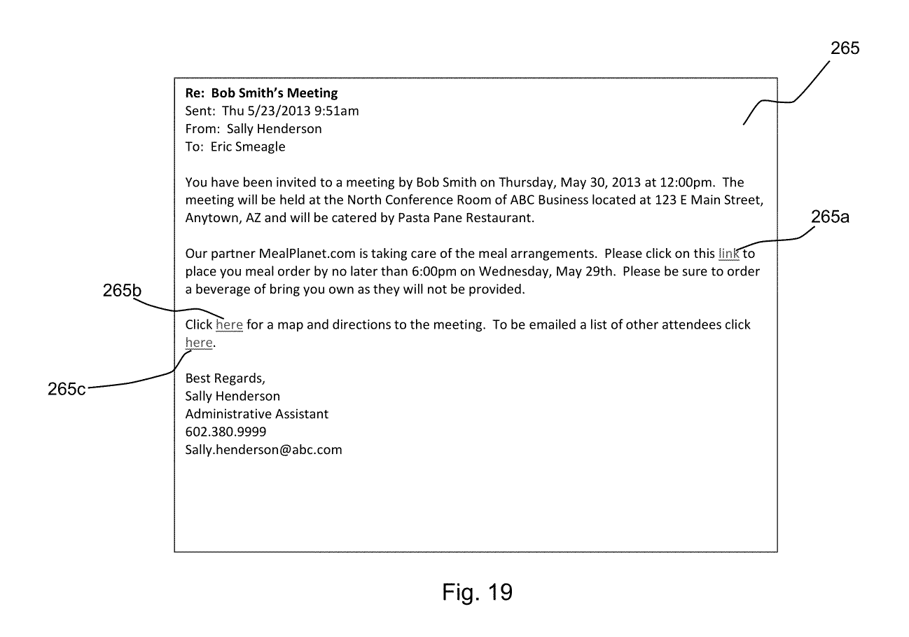

Referring to FIGS. 18-19, the server 12 can process the inputs and information received and initiate a “book notice” process 76. In certain embodiments, an email or like electronic messaging communication will be formulated for the identified attendees at step 260. The organizer or an administrator can review and approve the email at step 262. The notice can then be sent electronically to the restaurant via the network 15 at step 264 (e.g., email, fax, POS communication, etc.). An exemplary email notification 265 is shown in FIG. 19. The email can include link or other embedded means of providing the attendee with information or methods of proceeding with the meal order. For instance, a link 265a can be displayed and selected to direct the attendee to the meal ordering process. In addition, links to maps 265b, links to a list of other attendees 265c, and like information can be provided in the email. The service can monitor whether an attendee has placed his/her good order, or whether the attendee has expressly opted out of the ordering process. If the attendee simply hasn't responded, a reminder email or like notification can be re-sent to the attendee. Attendees can be added any time prior to the submission of the order to the restaurant. Further, the location, time, restaurant options, budget, etc. can be changed at any time by the organizer, at which time the attendees will be emailed a new notification email and permitted to place a new order as described herein.

Further, future meetings can be initiated and the who, what, where, and when attributes and details can be imported over from previous meetings with a simple selection of the previous meeting and a selection to copy the details over to the new meeting. From there, various details of the copied new meeting can be edited or altered by the organizer before sending a new notification out to the attendees. Various meetings can be tagged as recurring and the service can send recurring email notifications consistent with the frequency of the recurring meetings. Again, the organizer can edit the recurring meeting details as described herein for other meal meetings.

The restaurant user can then select to accept the meeting order at step 266, or send a return email to the organizer indicating that the meeting catering is declined at step 268. If the email invite is accepted by the restaurant, an email invite to all of the identified attendees is sent via the network 15 at step 270. The initiation of the “order meal” process 77 can proceed upon receipt of the email invite to the attendees. If the restaurant declined the opportunity for the meeting order, the organizer can return to the “book meeting” process 56.

### Ordering Component

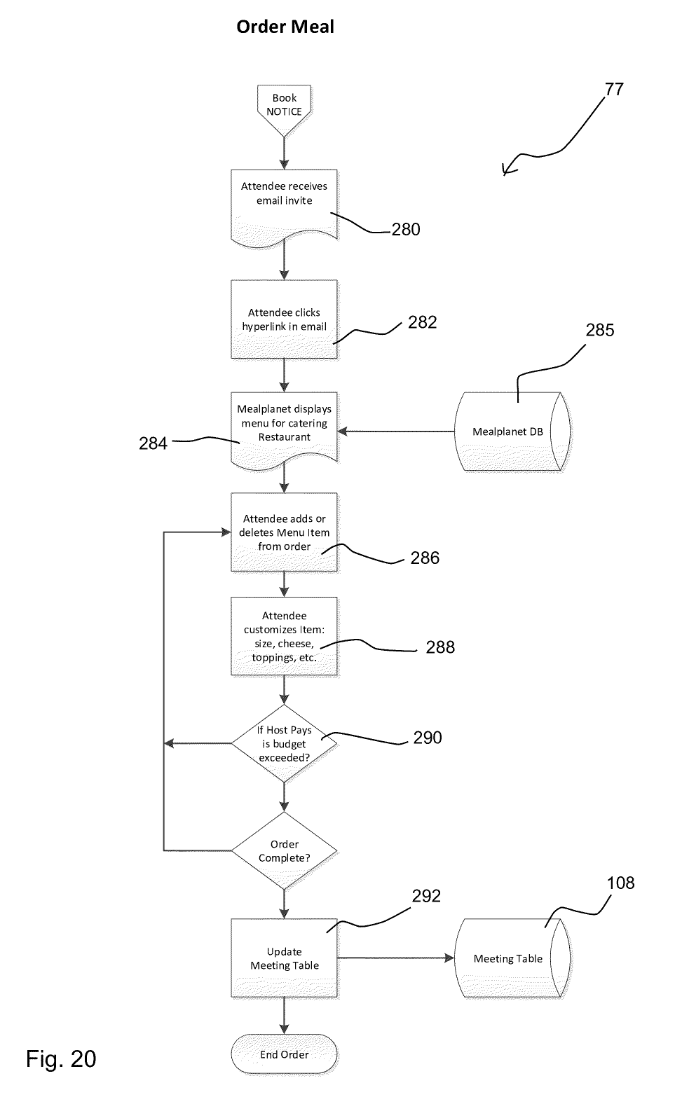

Referring to FIG. 20, an exemplary “order meal” process 77 is detailed. The attendee receives the email or like electronic communication at step 280, and can input select the hyperlink or like option 265a at step 282. As stated herein, other means of notifications and interaction between the server 12, the organizers, and the attendees can take place via mobile apps, other software, and the like. The system can then display the meal menu for the designated catering restaurant (e.g., via web browser interface, mobile/tablet app., etc.) at step 284. The details of the menu options displayed can come from the main database 285, which can include any of the table and database data identified herein. The attendee can then select the meal items at step 286, including specific customizations such as size, toppings, condiments, etc. at step 288. The process will then determine if the meal order exceeds or complies with the previously defined budget limitations at step 290. If not, then the attendee can be notified and returned to menu selection step 286. Otherwise, the order is determined complete and the meeting table 108 is updated with the inputted meal order details at step 292.

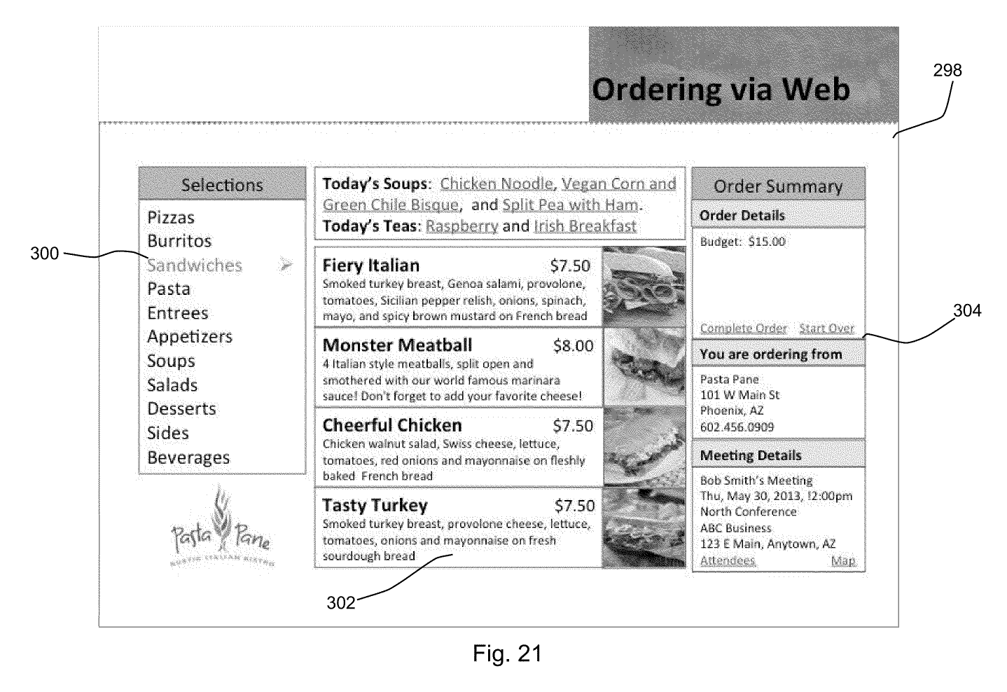

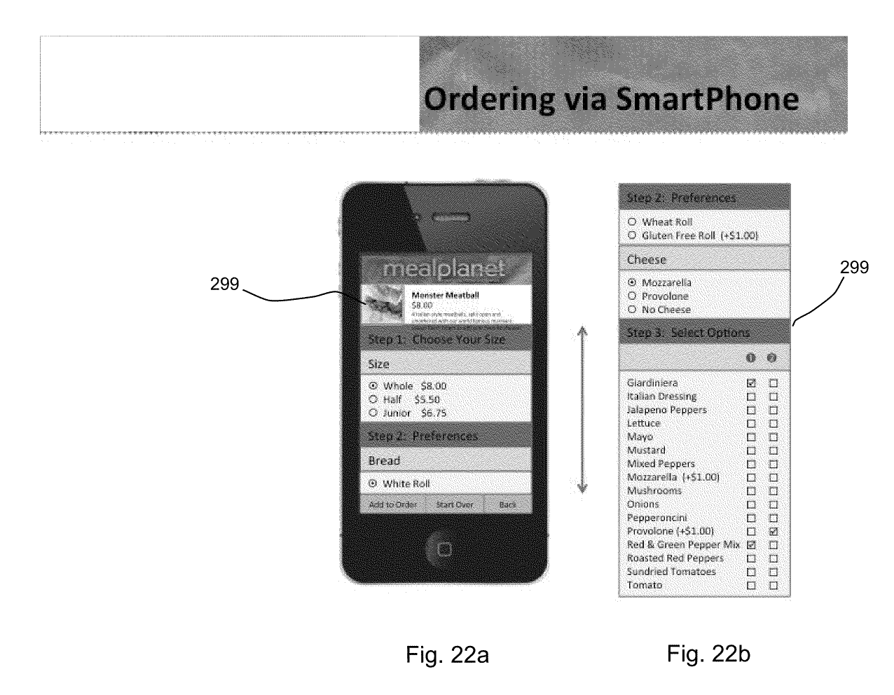

An exemplary restaurant order screen display 298, via web browser, is provided in FIG. 21. An exemplary restaurant order screen display 299 on a mobile or tablet app is provided in FIG. 22a, with a detailed scroll view of the options further depicted in FIG. 22b. The various selections for the ordering user interface can include the menu item selection (e.g., pizza, burritos, beverages, etc.) in display window 300. Menu options within that selection category can be displayed in display window 302. Updated order summary details can be displayed in window 304. Again, the menu options are selectable by the attendee in accordance with the processes detailed herein.

If the attendee for this meeting is paying for the meal, the service will capture payment information entered by the attendee. The service 10 can send a confirmation of the order details and payment receipt (if appropriate) to the attendee user (and/or meeting organizer) via email or other means.

### Restaurant Component

In addition to member/organizer and user registration, restaurants can sign into and enter pertinent details in the service 10 database. Options can be displayed to the restaurants upon registration to obtain inputs regarding various details of the restaurant, such as preferred payment methods, restaurant contact information, cuisine type, hours of operation, restricted diet options, delivery availability, delivery distance, delivery fees, etc. Upon receiving these and other details from the restaurant via the service 10, the options can be stored away in a database on the server for later use.

In general, an administrator of the service 10 or an administrative restaurant user of the service 10 will utilize the information received from the restaurant's inputs and other received data to build the service's restaurant menu, profile, advertisements, images, and the like. This menu and other details of the restaurant are displayed to the meeting organizer and attendees as disclosed herein.

While various embodiments have been described above, it should be understood that they have been presented by way of example only, and not limitation. Thus, the breadth and scope of the present disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the methods described above and illustrated in the drawings are shown as a sequence of steps, this was done solely for the sake of illustration. Accordingly, it is contemplated that some steps may be added, some steps may be omitted, the order of steps may be re-arranged, and some steps may be performed in parallel.

It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products.

For purposes of interpreting the claims for the present invention, it is expressly intended that the provisions of Section 112, sixth paragraph of 35 U.S.C. are not to be invoked unless the specific terms “means for” or “step for” are recited in a claim.

The following disclosure and pages provide an overview and additional details on the meal meeting organization system and service 10 of the present invention and is considered a part of this application, thereby being incorporated fully herein by reference.

What is claimed is:

1. A meal-based meeting booking method, comprising:
selecting attendee data for a meeting from a stored table of attendees;
selecting location data for the meeting from a table of meeting places;
selecting meal type data for the meeting;
processing at least the location data and the meal type data to select a meal service provider;
sending a notification providing ordering access related to the meal service provider;
displaying meal ordering options;
storing inputted meal ordering data; and
sending the inputted meal ordering data to the meal service provider.

2. The method of claim 1, further including selecting special diet requirements from a displayed diet list from stored attendee preference data.

3. The method of claim 1, further including selecting order price range limitations from a displayed range list.

4. The method of claim 1, wherein the notification is an electronic mail notification.

5. The method of claim 4, wherein the electronic mail notification includes a hyperlink to facilitate the ordering access from the meal service provider.

6. The method of claim 1, wherein the meal ordering options are displayed in a web browser interface.

7. The method of claim 1, wherein the meal ordering options are displayed in a portable device application.

8. A system for organizing and booking a meal-based meeting, comprising:
a server including a processor, a non-transitory memory, a storage database, a server output device, and a server input device;
an organizer user device including a processor, non-transitory memory, an input device, and an output device;
an attendee user device including a processor, non-transitory memory, an input device, and an output device; and
wherein the organizer user device is adapted to schedule a plurality of meeting details via the server such that a notification message is transmitted from the server to the attendee user device to provide a selectable link permitting a selection for each of the plurality of meeting details to define order data, and wherein the order data is transmitted to a restaurant user device.

9. The system of claim 8, wherein the organizer user device includes a web browser.

10. The system of claim 8, wherein the organizer user device includes a meal scheduling app.

11. The system of claim 8, wherein the attendee user device includes a web browser.

12. The system of claim 8, wherein the attendee user device includes a meal ordering app.

13. The system of claim 8, wherein the attendee user device is a smartphone device.

14. The system of claim 8, wherein the attendee user device is a computer device.

15. The system of claim 8, wherein the server includes at least one meal ordering database including an attendee table, a restaurant table, and an attendee table.
